(19) United States
(12) Patent Application Publication
(10) Pub. No.: US 2021/0394124 A1
(43) Pub. Date: Dec. 23, 2021

(54) SOLVENT ACTIVATION PROCESS FOR ENHANCING THE SEPARATION PERFORMANCE OF THIN FILM COMPOSITE MEMBRANES

(71) Applicant: KOREA UNIVERSITY RESEARCH AND BUSINESS FOUNDATION, Seoul (KR)

(72) Inventors: Jung Hyun LEE, Seoul (KR); Min Gyu SHIN, Paju-si (KR); Sung Joon PARK, Seoul (KR); Jin Young SEO, Busan (KR); Sung Kwon JEON, Bucheon-si (KR)

(73) Assignee: KOREA UNIVERSITY RESEARCH AND BUSINESS FOUNDATION, Seoul (KR)

(21) Appl. No.: 17/350,507

(22) Filed: Jun. 17, 2021

(30) Foreign Application Priority Data
Jun. 18, 2020 (KR) 10-2020-0074480

(51) Int. Cl. B01D 67/00; C08J 5/18; C08J 7/04; B01D 69/12; B01D 71/56; B01D 61/02

(52) U.S. Cl. CPC B01D 67/0006; C08J 5/18; C08J 7/0427; B01D 69/122; C08J 2477/06; B01D 61/025; B01D 61/027; C08J 2381/06; B01D 71/56

(57) ABSTRACT

The present invention relates to a method of manufacturing a high-performance thin film composite (TFC) membrane through a solvent activation process. In the present invention, by using a mixed solvent of a good solvent and a poor solvent as an activating solvent, a conventional polysulfone-based support-based TFC membrane having high water permeance as well as excellent salt rejection may be manufactured.

### CROSS-REFERENCE TO RELATED APPLICATION

This application claims priority to and the benefit of Korean Patent Application No. 2020-0074480, filed on Jun. 18, 2020, the disclosure of which is incorporated herein by reference in its entirety.

### BACKGROUND

### 1. Field of the Invention

The present invention relates to a method of manufacturing a high-performance thin film composite (TFC) membrane through a solvent activation process to enhance the separation performance of a conventional support-based TFC membrane having low solvent resistance.

### 2. Discussion of Related Art

Thin film composite (TFC) membranes refer to semi-permeable separation membranes, which consist of a selective layer that determines separation performance and a porous support that provides mechanical stability. As such, the TFC membrane is currently used as a key material in membrane separation processes for water treatment and seawater desalination.

As a support of the membrane, a polysulfone-based porous support having a surface pore size of 10 to 100 nm is generally used, and as a selective layer, a polyamide-based material is widely used. The selective layer is generally synthesized by interfacial polymerization of amine and acyl chloride monomers, and it is common to realize reverse osmosis membrane performance by manufacturing selective layers which have different structures using different types of monomers.

Recently, efforts have been made to improve the separation performance of the TFC membrane by optimizing polymerization conditions for the selective layer, using various additives, or performing post-treatment. Among these efforts, a post-treatment with a solvent, referred to as a solvent activation process, is known as a method capable of very simply and effectively improving the separation performance of the TFC membrane. However, since polysulfone or polyethersulfone, which is generally used as a support of the TFC membrane, has poor solvent resistance, a solvent activation process that can effectively enhance the separation performance of the polysulfone-based support-based TFC membrane has not been proposed.

Therefore, there is a need for the development of a novel method that can solve these problems.

### RELATED ART DOCUMENT

[Patent Document]

Korean Laid-Open Patent Publication No. 10-2010-0140150.

### SUMMARY OF THE INVENTION

The present invention is directed to providing a solvent activation method, which may effectively improve the separation performance of a thin film composite (TFC) membrane having low solvent resistance.

More particularly, the present invention is directed to providing a solvent activation method that can be applied to the polysulfone-based support-based TFC membrane having low solvent resistance by adjusting the solubility of an activating solvent using a mixed solvent in which a good solvent and a poor solvent are suitably mixed.

The present invention provides a method of manufacturing a TFC membrane, which includes treating a membrane comprising a polysulfone-based support; and a selective layer formed on the support with an activating solvent,

wherein the activating solvent comprises a good solvent and a poor solvent for the selective layer.

In addition, the present invention provides a TFC membrane which is manufactured by the above-described method of manufacturing a TFC membrane.

### BRIEF DESCRIPTION OF THE DRAWINGS

The above matters and other objects, features and advantages of the present invention will become more apparent to those of ordinary skill in the art by describing in detail exemplary embodiments thereof with reference to the accompanying drawing, in which:

FIG. 1 is a set of images illustrating the surface and cross-sectional structures of the TFC membrane manufactured according to Example 1 and Comparative Example 1.

### DETAILED DESCRIPTION OF EXEMPLARY EMBODIMENTS

Hereinafter, a method of manufacturing the thin film composite (TFC) membrane of the present invention will be described in detail.

The manufacturing method of the present invention includes treating a membrane including a polysulfone-based support and a selective layer formed on the support with an activating solvent. In the present invention, the treatment with a solvent may be referred to as “solvent activation” or “solvent activation process.”

The membrane including a polysulfone-based support and a selective layer formed on the support may be used by itself as a TFC membrane, but is expressed as a membrane to be distinguished from a TFC membrane that will be ultimately manufactured in a solvent activation step.

In the present invention, the support serves to support a selective layer and reinforce the mechanical strength of a TFC membrane. The support may have a porous structure.

In the present invention, the support may be a polysulfone-based support. The polysulfone-based support may be a commercially available product or synthesized. In one embodiment, the polysulfone-based support may be formed from a resin selected from the group consisting of polysulfone (PSF), polyethersulfone (PES), polyarylene sulfone, polybisphenol-A sulfone, polyphenylenesulfone, and Victrex HTA.

In one embodiment, the thickness of the support may be, but is not particularly limited to, for example, 5 to 200 μm, 10 to 200 μm, 20 to 200 μm, or 70 to 100 μm. Within the above-mentioned thickness range, excellent performance as a TFC membrane may be realized. Even when the thickness of the support is more than 200 μm, the support has physical properties and performance required for use as a membrane, but water permeance may decrease, and manufacturing cost may increase. Therefore, it is preferable to adjust the thickness of the support to 5 to 200 μm.

In one embodiment, the support may have a pore size of 200 nm or less or 10 to 200 nm. Since the density of the selective layer may not decrease within the above-mentioned pore size range, a TFC membrane having excellent salt rejection may be manufactured. When the pore size is more than 200 nm, pinhole defects may be created in the selective layer, which may result in the deterioration of salt rejection.

In one embodiment, the support may have a porosity (void fraction) of 20 to 70%, 30 to 70%, 40 to 70% or 50 to 70%. Within the above-mentioned range, a permeate flux is excellent, and the strength of the support is excellent.

In the present invention, the selective layer may be formed on the polysulfone-based support, and may consist of one or more compounds selected from the group consisting of polyamide, aromatic polyhydrazide, polybenzimidazolone, polyepiamine/amide, polyepiamine/urea, polyethyleneimine/urea, sulfonated polyfurane, polybenzimidazole, polypiperazine isophtalamide, polyether, polyetherurea, polyester, and polyimide.

In one embodiment, the selective layer may have a thickness of 1 to 10,000 nm.

In the present invention, the selective layer may be formed by an interfacial polymerization, dip coating, spray coating, spin coating, layer-by-layer assembly, or dual slot coating method, and in the present invention, is preferably formed by an interfacial polymerization method.

In one embodiment, the formation of the selective layer through an interfacial polymerization method may include: impregnating or coating the support with the first solution including the first organic monomer;

adjusting the content of the first organic monomer on the support;

impregnating or coating the support with the second solution including the second organic monomer;

forming a selective layer by interfacial polymerization of the first organic monomer and the second organic monomer dissolved in the first solution and the second solution, respectively; and

removing the residual second organic monomer.

In one embodiment, the type of the first organic monomer is not particularly limited, and for example, the first organic monomer may be a molecule having an amine or hydroxyl group, which may be one or more selected from the group consisting of m-phenylene diamine (MPD), o-phenylene diamine (OPD), p-phenylene diamine (PPD), piperazine, m-xylenediamine (MXDA), ethylenediamine, trimethylenediamine, haxamethylenediamine, diethylene triamine (DETA), triethylene tetramine (TETA), methane diamine (MDA), isophoroediamine (IPDA), triethanolamine, polyethyleneimine, methyl diethanolamine, hydroxyakylamine, hydroquinone, resorcinol, catechol, ethylene glycol, glycerine, polyvinyl alcohol, 4,4′-biphenol, methylene diphenyl diisocyanate, m-phenylene diisocyanate, p-phenylene diisocyanate, and toluene diisocyanate.

In one embodiment, the type of the first solvent may be, but is not particularly limited to, for example, water, methanol, ethanol, propanol, butanol, isopropanol, ethyl acetate, acetone, chloroform, tetrahydrofuran (THF), dimethyl sulfoxide (DMSO), N,N-dimethylformamide (DMF), and N-methyl-2-pyrrolidone (NMP).

In one embodiment, the first organic monomer may be contained in the first solution at 0.1 to 10 wt % or 1 to 5 wt %.

In one embodiment, the type of the second organic monomer may be, but is not particularly limited to, for example, one or more selected from the group consisting of trimesoyl chloride (TMC), terephthaloyl chloride, isophthaloyl chloride, cyclohexane-1,3,5-tricarbonyl chloride, 5-isocyanato-isophthaloyl chloride, cyanuric chloride, trimellitoyl chloride, phosphoryl chloride, and glutaraldehyde.

In addition, in one embodiment, the type of the second solvent may be, but is not particularly limited to, for example, one or more selected from the group consisting of n-hexane, pentane, cyclohexane, heptane, octane, carbon tetrachloride, benzene, xylene, toluene, chloroform, tetrahydrofuran, and isoparaffin.

In one embodiment, the second organic monomer may be included at 0.01 to 4 wt % or 0.1 to 2 wt %.

The above-described first solution in the present invention may include an amine monomer, the second solution includes an acyl chloride monomer, and a polyamide selective layer may be synthesized by interfacial polymerization between the monomers.

In one embodiment, the step of adjusting the content of the first organic monomer on the support is to remove an excessive amount of the first solution on the surface of the support, and may be performed using an air gun or a roller.

In addition, in the manufacturing method according to the present invention, a washing step after the formation of the selective layer may be further included.

Through the above-described process in the present invention, a membrane including the polysulfone-based support on which the selective layer is formed is manufactured.

In the present invention, after the membrane is manufactured, the membrane may be treated with an activating solvent (solvent activation step or solvent activation process), and particularly, the membrane including the support on which the selective layer is formed, that is, the polysulfone-based support, and the selective layer formed on the support may be treated with an activating solvent.

In the present invention, the activating solvent includes a good solvent and a poor solvent for the selective layer.

Through the solvent activation process, a TFC membrane which exhibits a wide range of performance from reverse osmosis (RO) to nanofiltration (NF) and has excellent salt rejection as well as high water permeance may be manufactured.

Generally, in terms of the change in the separation performance of the membrane through the solvent activation process, it is known that a solvent activation effect is excellent when a solvent with high solubility (compatibility or affinity) for a selective layer material is used. However, in the case of a commercially available polysulfone-based support, due to the lack of resistance to a solvent with high solubility for the selective layer, it is impossible to employ an appropriate solvent activation process. In the present invention, the separation performance of the membrane may be enhanced by adjusting the solubility of the activating solvent using the mixed solvent of a good solvent and a poor solvent for the selective layer material.

In the present invention, the good solvent means a solvent that can dissolve the selective layer material or greatly swell its structure due to high compatibility (affinity) with the selective layer, and the poor solvent refers to a solvent that has difficulty in deforming (swelling) the structure of the selective layer due to low compatibility (affinity) with the selective layer material.

When the membrane is treated with the activating solvent according to the present invention, debris, fragments, and unreacted materials present in the selective layer formed by interfacial polymerization are removed, and particularly, when the selective layer is brought into contact with the activating solvent, the selective layer may be swollen due to its high compatibility (affinity) with the activating solvent, and internal debris and fragments may be dissolved. Therefore, the structural change of the selective layer may occur. Accordingly, the water permeance and salt rejection of the TFC membrane may be improved.

In one embodiment, as an activating solvent, the mixed solvent of a good solvent and a poor solvent for polyamide may be used. That is, as a good solvent, a solvent that can greatly swell the polyamide structure due to its high compatibility (affinity) with a crosslinked polyamide may be used, and as a poor solvent, a solvent that cannot greatly swell the polyamide structure may be used.

In one embodiment, the good solvent may be one or more selected from the group consisting of benzyl alcohol, dimethyl sulfoxide (DMSO), N,N-dimethylformamide (DMF), gamma-valerolactone, gamma-butyrolactone, dimethylacetamide, and N-methyl-2-pyrrolidone (NMP), and the poor solvent may be one or more selected from the group consisting of water, ethanol, methanol, propanol, butanol, tetrahydrofuran, acetone, and acetonitrile.

Preferably, in the present invention, as a good solvent, dimethyl sulfoxide (DMSO) or N-methyl-2-pyrrolidone (NMP) may be used, and as a poor solvent, water or alcohol may be used. Particularly, DMSO and water have no toxicity and low volatility, and therefore may be readily used as a good solvent and a poor solvent, respectively.

In one embodiment, the mixing ratio of the good solvent and the poor solvent is not particularly limited, and the volume proportion of the good solvent in the mixed solvent may be 5 to 95%, 10 to 90%, 10 to 60%, or 20 to 40%. Particularly, the mixing ratio may vary according to the application of the manufactured TFC membrane, and when the membrane is used in a RO process, the volume proportion of the good solvent in the mixed solvent may be 5 to 70%, 10 to 70%, 10 to 60%, or 20 to 40%, and when the membrane is used in a NF process, the volume proportion of the good solvent in the mixed solvent may be 5 to 70%, 10 to 70%, 30 to 70%, or 50 to 70%. As the volume proportion of the good solvent is adjusted, the separation performance of the membrane may be improved.

In the present invention, a treatment time of the activating solvent, that is, the time for a solvent activation process, may be 1 second to 48 hours, 10 to 40 hours, 15 to 30 hours, or 20 to 25 hours. The activating solvent of the present invention exhibits an activation effect immediately after starting the treatment. When the treatment is longer than 48 hours, an additional treatment effect may not be obtained, and process efficiency is lowered. Therefore, treatment for less than 48 hours is preferable in terms of process efficiency.

In addition, the treatment temperature of the activating solvent may be −60 to 100° C., 10 to 100° C., or 25 to 90° C. Generally, the treatment temperature is inversely proportional to the treatment time, and the higher the treatment temperature, the shorter the treatment time is. However, since the treatment effect is different depending on the type of the activating solvent, and the freezing and boiling points of the activating solvents and the glass transition temperature of the support that can be used are different, in consideration of the above facts, the activating solvent should preferably be treated at 25 to 90° C.

In addition, the treatment of the activating solvent may be performed by a surface contact, impregnation, air spraying, or permeation method.

In addition, the present invention relates to the TFC membrane manufactured by the above-described method of manufacturing a TFC membrane.

The TFC membrane according to the present invention has high water permeance as well as excellent salt rejection.

Particularly, as the support according to the present invention, a polysulfone-based support is used, and the membrane manufactured through interfacial polymerization has improved separation properties through the solvent activation process. Therefore, a TFC membrane having excellent separation performance may be provided.

The TFC membrane may be applied to a reverse osmosis (RO), nanofiltration (NF), forward osmosis (FO), pressure retarded osmosis (PRO), pressure-assisted osmosis (PAO), or gas separation process.

Particularly, the membrane developed in the present invention may be applied to a RO or NF process for seawater desalination. The TFC membrane manufactured according to the present invention may have salt rejection required for a RO or NF process and high permeate flux even under low pressure.

In one embodiment, when the TFC membrane is applied to a RO process, a process pressure may be 15 to 50 bar. In addition, under the conditions of a flow rate of 1 L min⁻¹, a pressure of 15.5 bar, and 2,000 ppm of a NaCl aqueous solution, water permeance may be 1 to 5 L m⁻² h⁻¹ bar⁻¹ or 2.5 to 7 L m⁻² h⁻¹ bar⁻¹, and salt (NaCl) rejection may be 90% or more, 95% or more, or 98% or more.

In addition, in one embodiment, when applied to a NF process, the process pressure may be 10 bar or less, or 5 bar or less. In addition, under the conditions of a flow rate of 0.5 L min⁻¹, a pressure of 10 bar, and 1,000 ppm of a MgSO₄, Na₂SO₄, MgCl₂, or NaCl aqueous solution, water permeance may be 9 to 20 L m⁻² h⁻¹ bar⁻¹ or 10 to 18 L m⁻² h⁻¹ bar⁻¹, and salt rejection may be 40% or more, 50% or more, or 70% or more for a monovalent salt (MgCl₂ or NaCl), and 90% or more, 95% or more, or 98% or more for a divalent salt (MgSO₄ or Na₂SO₄).

### EXAMPLES

### Example 1 and Comparative Example 1. Manufacturing of TFC Membranes Using DMSO/Water as an Activating Solvent

1) Porous Support

A polysulfone support (PS20, Nanostone Water Inc.) used for a commercially available TFC membrane was used.

2) Manufacturing of a Selective Layer

Water was used as the first solvent (hydrophilic solvent) of the first solution, and m-phenylenediamine (MPD) was used as the first organic monomer included therein.

N-hexane was used as the second solvent (organic solvent) of the second solution, and trimesoyl chloride (TMC) was used as the second organic monomer included therein.

The selective layer was manufactured through interfacial polymerization as follows.

\textcircled{1} A support was washed with isopropyl alcohol and water.

\textcircled{2} The washed support was fixed with a reaction frame, and the first solution containing 3 wt % MPD was poured to impregnate the support with the first solution for 3 minutes.

\textcircled{3} The excessive amount of the first solution on the surface of the support was removed, and the support was brought into contact with the second solution containing 0.1 wt % TMC for 1 minute, thereby synthesizing a polyamide selective layer through polymerization between the monomers at the interface of the solution.

\textcircled{4} The unreacted second organic monomer was washed and removed with a solvent that had been used for the second solution, and then dried.

Thereby, a membrane was manufactured.

3) Solvent Activation Process

As an activating solvent, a mixed solvent of dimethyl sulfoxide (DMSO), which is a good solvent, and water, which is a poor solvent, was used. Here, the volume proportion of DMSO in the mixed solvent was adjusted to 0 to 100%. Specifically, the volume proportion of DMSO in the activating solvent was 0% in Comparative Example 1-1, 30%, 60% and 90% in Examples 1-1, 1-2 and 1-3, respectively, and 100% in Comparative Example 1-2.

A solvent activation process was performed as follows.

\textcircled{1} The membrane manufactured in the step 2) “Manufacturing of a selective layer” was brought into contact with an activating solvent.

\textcircled{2} The membrane was brought into contact with the activating solvent for a predetermined time (1 to 24 hours), and the membrane was subsequently washed with deionized water.

\textcircled{3} After the solvent activation process was completed, the TFC membrane was stored in deionized water prior to performance measurement.

### Example 2. Commercially Available Membranes Obtained after the Solvent Activation Process (Using DMSO/Water as an Activating Solvent)

Commercially available membranes in Table 1 below were subjected to a solvent activation process.

The solvent activation process was carried out by the method described in Example 1. 3) Solvent activation process using an activating solvent (DMSO/water, the volume proportion of DMSO: 30% in Examples 2-1 to 2-5 and 60% in Example 2-6).

TABLE 1

| | Application | Commercially available |
|---|---|---|
| Example | process | membrane (manufacturer) |
| Example 2-1 | RO | SW30LE (Dow Filmtec) |
| Example 2-2 | RO | SW30HR (Dow Filmtec) |
| Example 2-3 | RO | BW30LE (Dow Filmtec) |
| Example 2-4 | RO | BW30 (Dow Filmtec) |
| Example 2-5 | RO | SWC4+ (Hydranautics) |
| Example 2-6 | NF | NF270 (Dow Filmtec) |

### Example 3 and Comparative Example 3. Commercially Available Membranes Obtained after the Solvent Activation Process (Using NMP/Water as an Activating Solvent)

A commercially available membrane, SWC4+, was subjected to a solvent activation process. The solvent activation process was carried out by the method described in Example 1. 3) Solvent activation process using an activating solvent (NMP/water).

Specifically, the volume proportion of NMP in the activating solvent was 0% in Comparative Example 3-1, 30% and 60% in Examples 3-1 and 3-2, respectively, and 90% in Comparative Example 3-2.

### Experimental Example 1. Surface Structures of the TFC Membranes Manufactured Through the Solvent Activation Process

The structure of the TFC membrane manufactured through the solvent activation process using an activating solvent having different DMSO volume proportions has been characterized.

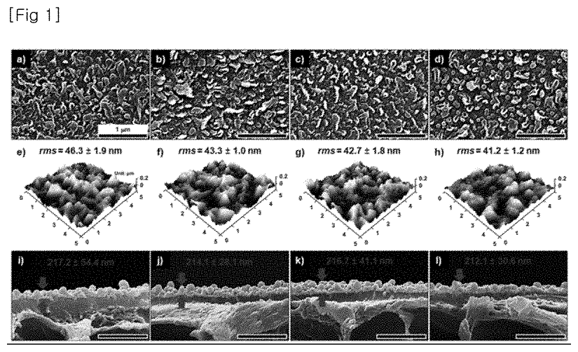

In the present invention, FIG. 1 is a set of images illustrating the surface and cross-sectional structures of the TFC membranes manufactured according to Example 1 and Comparative Example 1. Specifically, a) to d) are the surface SEM images of the selective layers, e) to h) are the surface AFM images of the selective layers, and i) to l) are the cross-sectional SEM images of the TFC membranes. In addition, a), e), and i) are the images of the TFC membrane manufactured according to Comparative Example 1-1, b), f), and j) are the images of the TFC membrane manufactured according to Example 1-1, c), g), and k) are the images of the TFC membrane manufactured according to Example 1-2, and d), h), and l) are the images of the TFC membrane manufactured according to Example 1-3.

The selective layer of the TFC membrane according to Comparative Example 1-1 has a rough surface structure (e.g., ridge-and-valley features). However, it can be confirmed that the nodular features of the selective layer of the TFC membrane according to an example using an activating solvent containing 30 to 90% DMSO are relatively suppressed in comparison with Comparative Example 1-1. That is, as the DMSO content increases, the rms surface roughness of the membrane tends to decrease, which is caused by swelling of the selective layer or dissolution of debris and fragments in the selective layer through the solvent activation process. In addition, it can be confirmed that there is no significant change in the thickness of the selective layer by the use of an activating solvent.

Meanwhile, in the case of Comparative Example 1-2 using 100% DMSO, the support is dissolved, and thus the surface structure was not able to be measured.

### Experimental Example 2. Performance Experiment

To evaluate RO performance, a permeation test was performed under the process conditions of a flow rate of 1 L/min, a pressure of 15.5 bar, and 2,000 ppm of a NaCl aqueous solution, and to evaluate NF performance, a permeation test was performed under the process conditions of a flow rate of 0.5 L/min, a pressure of 10 bar, and 1,000 ppm of a MgSO₄, Na₂SO₄, MgCl₂, or NaCl aqueous solution, thereby evaluating water permeance and salt rejection. In addition, all performance measurements were carried out at 25±0.5° C.

### (1) Performance Results for the TFC Membranes According to Example 1 and Comparative Example 1

The RO performance of the TFC membranes manufactured in Example 1 and Comparative Example 1 was evaluated and compared, as shown in Table 2 below.

TABLE 2

| | Volume proportion | Water permeance | NaCl |
|---|---|---|---|
| | (%) of DMSO | (L m⁻² h⁻¹ bar⁻¹) | rejection (%) |
| Comparative | 0 (untreated) | 2.1 ± 0.3 | 99.4 ± 0.1 |
| Example 1-1 | | | |
| Example 1-1 | 30 | 3.0 ± 0.3 | 99.4 ± 0.2 |
| Example 1-2 | 60 | 4.5 ± 0.5 | 98.3 ± 0.5 |
| Example 1-3 | 90 | 6.3 ± 0.8 | 95.2 ± 0.9 |
| Comparative | 100 | 1000 | 0 |
| Example 1-2 | | | |

As shown in Table 2, when the mixed solvent of a good solvent (DMSO) and a poor solvent (water) was used as an activating solvent according to the present invention, it can be confirmed that permselectivity can be controlled through the solvent activation process.

When water alone was used as an activating solvent, excellent NaCl rejection but low water permeance were resulted. In addition, when DMSO alone was used, the polysulfone-based support was dissolved, and thus the membrane was not able to function properly. On the other hand, when an activating solvent with a DMSO volume proportion of 30% was used, excellent NaCl rejection and 43%-improved water permeance were obtained. That is, it can be confirmed that the use of an activating solvent according to the present invention results in the manufacturing of desired TFC membranes having excellent water permeance and salt rejection.

In addition, in comparison with SWC4+(not subjected to solvent activation process), which is a commercially available RO membrane, it can be confirmed that the TFC membranes according to the present invention exhibit exceptionally excellent water permeance and NaCl rejection.

### (2) Performance Results for the Commercially Available Membranes According to Example 2

The RO and NF performance of the commercially available membranes according to Example 2 was evaluated.

The RO and NF performance results are shown in Table 3 and Table 4 below, respectively.

Here, salt selectivity was calculated as follows.

Salt selectivity=(100−NaCl rejection)/(100−Na₂SO₄ rejection)

TABLE 3

| | | | Before solvent | | After solvent | |
|---|---|---|---|---|---|---|
| | | | activation | | activation | |
| | | | Water | | Water | |
| | | | permeance | NaCl | permeance | NaCl |
| | | | (L m⁻² | rejection | (L m⁻² | rejection |
| | | | h⁻¹ bar⁻¹) | (%) | h⁻¹ bar⁻¹) | (%) |
| Example | RO | SW30LE | 1.1 ± 0.1 | 98.7 ± 0.1 | 2.8 ± 0.1 | 99.4 ± 0.2 |
| 2-1 | | | | | | |
| Example | RO | SW30HR | 1.0 ± 0.4 | 98.0 ± 1.1 | 1.8 ± 0.1 | 98.7 ± 0.1 |
| 2-2 | | | | | | |
| Example | RO | BW30LE | 2.9 ± 0.1 | 99.6 ± 0.4 | 4.5 ± 0.2 | 99.7 ± 0.1 |
| 2-3 | | | | | | |
| Example | RO | BW30 | 3.6 ± 0.6 | 98.3 ± 0.5 | 6.1 ± 0.6 | 98.6 ± 0.1 |
| 2-4 | | | | | | |
| Example | RO | SWC4+ | 1.5 ± 0.1 | 97.1 ± 0.5 | 1.9 ± 0.1 | 97.6 ± 0.5 |
| 2-5 | | | | | | |

TABLE 4

| | Water | | | | | |
|---|---|---|---|---|---|---|
| | permeance | | | | | Salt |
| | (L m⁻² | Salt rejection (%) | | | | selectivity |
| | h⁻¹ bar⁻¹) | NaCl | MgCl₂ | Na₂SO₄ | MgSO₄ | (Cl⁻/SO₄²⁻) |
| Before | 12.4 | 57.3 | 74.0 | 99.1 | 98.5 | 47.4 |
| solvent | | | | | | |
| activation | | | | | | |
| After | 14.5 | 49.5 | 70.2 | 99.1 | 98.4 | 56.1 |
| solvent | | | | | | |
| activation | | | | | | |

As shown in Table 3, when the commercially available RO membrane is treated with the activating solvent according to the present invention, water permeance and NaCl rejection are enhanced, thereby improving permselectivity.

In addition, as shown in Table 4, when the commercially available NF membrane is treated with the activating solvent according to the present invention (Example 2-6), it can be confirmed that water permeance and mono/divalent ion selectivity are improved.

### (3) Performance Results for the Commercially Available Membranes According to Example 3 and Comparative Example 3

The changes in the RO performance of the commercially available membrane (SWC4+) according to Example 3 and Comparative Example 3 were evaluated, as shown in Table 5 below.

TABLE 5

| | Volume proportion (%) | Water permeance | NaCl |
|---|---|---|---|
| | of NMP (%) | (L m⁻² h⁻¹ bar⁻¹) | rejection (%) |
| Comparative | 0 (untreated) | 1.5 ± 0.1 | 99.6 ± 0.4 |
| Example 3-1 | | | |
| Example 3-1 | 30 | 1.9 ± 0.1 | 99.7 ± 0.4 |
| Example 3-2 | 60 | 1.9 ± 0.2 | 99.7 ± 0.4 |
| Comparative | 90 | leak | 0 |
| Example 3-2 | | | |

As shown in Table 5, when the mixed solvent of a good solvent (NMP) and a poor solvent (water) is used as an activating solvent according to the present invention, it can be confirmed that permselectivity can be controlled through the solvent activation process, and a desired TFC membrane having excellent water permeance and salt rejection can be manufactured.

These results demonstrate that the permselectivity of a TFC membrane may be improved through the solvent activation process and controlled depending on the type of the solvent utilized for the targeted use of the membrane.

The solvent activation technique for a TFC membrane according to the present invention can be easily applied even to a TFC membrane including a conventional polysulfone-based support having low solvent resistance by adjusting the solubility of an activating solvent. The TFC membrane manufactured according to the present invention can exhibit unchanged or improved salt rejection along with enhanced (up to 155%) water permeance.

In addition, the TFC membrane according to the present invention can be applied to a RO or NF process requiring high separation performance, or can also be applied to a FO, PRO, PAO, or gas separation process.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of manufacturing a thin film composite (TFC) membrane, comprising:
treating a membrane comprising a polysulfone-based support; and a selective layer formed on the support with an activating solvent,
wherein the activating solvent comprises a good solvent and a poor solvent for the selective layer.

2. The method of claim 1, wherein the polysulfone-based support is formed from one or more resins selected from the group consisting of polysulfone (PSF), polyethersulfone (PES), polyarylene sulfone, polybisphenol-A sulfone, polyphenylene sulfone, and Victrex HTA.

3. The method of claim 1, wherein the selective layer comprises one or more selected from the group consisting of polyamide, aromatic polyhydrazide, polybenzimidazolone, polyepiamine/amide, polyepiamine/urea, polyethylenimine/urea, sulfonated polyfuran, polybenzimidazole, polypiperazine isophthalamide, polyether, polyether urea, polyester, and polyimide.

4. The method of claim 1, wherein the selective layer is formed by an interfacial polymerization, dip coating, spray coating, spin coating, layer-by-layer assembly, or dual slot coating method.

5. The method of claim 1, wherein the selective layer is manufactured by:
impregnating or coating the support with the first solution containing the first organic monomer;
adjusting the content of the first organic monomer on the support;
impregnating or coating the support with the second solution containing the second organic monomer;
forming a selective layer by interfacial polymerization of the first organic monomer and the second organic monomer dissolved in the first solution and the second solution, respectively; and
removing the residual second organic monomer.

6. The method of claim 5, wherein the first organic monomer is one or more selected from the group consisting of m-phenylene diamine (MPD), o-phenylene diamine (OPD), p-phenylene diamine (PPD), piperazine, m-xylenediamine (MXDA), ethylenediamine, trimethylenediamine, haxamethylenediamine, diethylene triamine (DETA), triethylene tetramine (TETA), methane diamine (MDA), isophoroediamine (IPDA), triethanolamine, polyethyleneimine, methyl diethanolamine, hydroxyakylamine, hydroquinone, resorcinol, catechol, ethylene glycol, glycerine, polyvinyl alcohol, 4,4′-biphenol, methylene diphenyl diisocyanate, m-phenylene diisocyanate, p-phenylene diisocyanate, and toluene diisocyanate.

7. The method of claim 5, wherein the solvent for the first solution is one or more selected from the group consisting of water, methanol, ethanol, propanol, butanol, isopropanol, ethyl acetate, acetone, chloroform, tetrahydrofuran (THF), dimethyl sulfoxide (DMSO), N,N-dimethylformamide (DMF), and N-methyl-2-pyrrolidone (NMP).

8. The method of claim 5, wherein the second organic monomer is one or more selected from the group consisting of trimesoyl chloride (TMC), terephthaloyl chloride, isophthaloyl chloride, cyclohexane-1,3,5-tricarbonyl chloride, 5-Isocyanato-isophthaloyl chloride, cyanuric chloride, trimellitoyl chloride, phosphoryl chloride, and glutaraldehyde.

9. The method of claim 5, wherein the solvent for the second solution is one or more selected from the group consisting of n-hexane, pentane, cyclohexane, heptane, octane, carbon tetrachloride, benzene, xylene, toluene, chloroform, tetrahydrofuran, and isoparaffin.

10. The method of claim 1, wherein the good solvent for the selective layer is one or more selected from the group consisting of benzyl alcohol, dimethyl sulfoxide (DMSO), N,N-dimethylformamide (DMF), gamma-valerolactone, gamma-butyrolactone, dimethylacetamide, and N-methyl-2-pyrrolidone (NMP), and
the poor solvent is one or more selected from the group consisting of water, ethanol, methanol, propanol, butanol, tetrahydrofuran, acetone, and acetonitrile.

11. The method of claim 1, wherein a treatment time of the activating solvent is 1 second to 48 hours.

12. The method of claim 1, wherein a treatment temperature of the activating solvent is −60 to 100° C.

13. The method of claim 1, wherein the treatment of the activating solvent is performed using a surface contact, impregnation, air spraying, or permeation method.

14. A TFC membrane manufactured by the manufacturing method according to claim 1.

15. The TFC membrane of claim 14, which is applied to a reverse osmosis (RO), nanofiltration (NF), forward osmosis (FO), pressure retarded osmosis (PRO), pressure assisted osmosis (PAO), or gas separation process.
